(19) United States
(12) Patent Application Publication
(10) Pub. No.: US 2013/0144790 A1
(43) Pub. Date: Jun. 6, 2013

(54) Data Automation

(71) Applicant: Walter Clements, Chicago, IL (US)

(72) Inventor: Walter Clements, Chicago, IL (US)

(21) Appl. No.: 13/706,210

(22) Filed: Dec. 5, 2012

Related U.S. Application Data
(60) Provisional application No. 61/567,292, filed on Dec. 6, 2011.

(51) Int. Cl. G06F 19/00

(52) U.S. Cl. CPC G06F 19/322
USPC 705/51

(57) ABSTRACT

A user friendly process and system are provided for healthcare payers and providers to automate access to information from disparate systems accurately and in real time, to reduce healthcare costs and improve healthcare quality and outcomes. In some circumstances, it may be desirable to use the efficient process and system for other purposes.

### CROSS REFERENCES TO RELATED APPLICATIONS

This application is based upon priority U.S. Provisional Application No. 61/567,292 filed Dec. 6, 2011.

### BACKGROUND OF THE INVENTION

This invention relates to personal health information, and more particularly, to data automation of personal health information.

Personal health information (PHI) as it exists today widely lacks accurate and complete clinical data content as a result of this content not being easily made available from across a wide variety of clinical systems and data sources. The reason for this dearth of clinical data availability is that the many, various and disparate source systems that contain this data are structured on platforms that do not communicate directly with one another. In many cases the design of these systems makes sharing information between other competing systems very difficult, whether intentionally or unintentionally.

The ability to bring accurate and complete clinical health data into the health record of a patient or population is valuable to individual patients as well as private and public interests that are responsible as payers to health care providers on behalf of their constituents. This value is based on the ability to better understand individual and population health care risks and costs, and fundamentally to enable individuals to enjoy a longer, healthier and thereby higher quality of life.

It is therefore desirable to provide an improved data automation process and system which overcomes most, if not all, of the preceding problems.

### BRIEF SUMMARY OF THE INVENTION

An improved data automation solution, process and system are provided which is easy to use, economical, efficient and effective. Advantageously, the user friendly data automation solution, process and system readily retrieves, compiles, indexes, and transforms data with different formatting styles from disparate sources into a single universal formatting style for transmission to authorized requestors.

Data source connectivity can be automated through a software transfer service that can be installed inside the network of the client data source. This transfer software service can include a file whose purpose is to receive clinical data from the originating data source system and to transfer this data to the data gateway. This transfer service can be a Windows compatible service that can reside on a computer within the network of the incoming data source. This service can monitor a set of folders on the network for new files and transmit them to the data gateway for processing. The data gateway can be a secure IIS web service application that resides in the front of the data warehouse. The data gateway can be the direct point of communications between the PHI transfer service and the data warehouse. The Data warehouse can be a standardized data structure that will store all inbound PHI data for the purposes of aggregation and reporting. The exchange, transform, load (ETL) process can take all incoming PHI data in the raw data format (HL7 2.x), parse the data based on the standard and any specific variations for the incoming data source, and populate the data warehouse. The ETL process can be composed of the message decrypter, message standardizer, message normalizer, master patient index and the warehouse loader. The web based query tool can be an ASP.Net web site that provides a secure platform for authorized individuals to query the data warehouse and generate reports. The basic administration site can be an ASP.Net web site that will provide a secure platform for monitoring and administering the entire system.

Advantages to this system can include its ability to run queries on data from any requesting data source system to any data contained in any data originating source system; its ability to automate, monitor and maintain connectivity to the originating data source system regardless of any system data structure; its management of this connectivity with a limitless number and variety of originating data source systems; its ability to obtain new or changed data from the originating data source system in real-time as that source system data is inputted, updated or refreshed itself; its secure transfer of raw data from the originating data source system to the clinical data automation solution central processor; its cleaning of this raw data to remove irregularities or errors in the data; its parsing and translating of the cleaned data into a format that is consistent with that of the files that exist the central data repository; its accurate matching of data with the relevant patient file in the central data repository; its insertion of this data into the existing central data repository file; its remediation process for data that does not match already existing patients in the central data repository file; its identifying data in files in the central data repository that is requested by any requesting data source system; its formatting this data into any readable format required by the requesting data source system; and its secure transfer of this requesting data source formatted data into the requesting data source system.

These advantages enable a user of any requesting data source system to access any data from any originating data source system through automated or ad-hoc data queries for the purpose of performing analysis of this data; generating reports on this data; creating alerts as to the existence or non-existence of data based on any parameters; and returning analytic results, reports and alerts from any requesting data source system back to any originating data source system as a synchronized feedback loop.

One embodiment of data automation can provide health insurance payers clinical data on their insured members for analysis of physician encounter and lab test results information to identify members who have developed or are at risk of developing a specific disease or adverse medical condition. Data can be obtained from any of the many electronic health record (EHR) systems that are in use by primary care physicians and physician specialists, from any hospital information systems (HIS) containing data on patients receiving acute care or undergoing clinical procedures, and from any of the many laboratory information systems (LIS) that are used by clinical laboratories from which physicians order clinical tests. Data from these multiple systems can be aggregated in the clinical data automation solution into one uniform and recognized standard, as a single patient health record for a member. Data in this standardized, complete patient health record can be analyzed by any requesting data source system to identify indicators for adverse health conditions and any other desired strategic trend analysis by health insurance payers.

Another embodiment of data automation can be to provide disease management programs and companies with a more accurate and complete picture of their clients' clinical results information stored in EHRs, HISs, LISs and other desired clinical data sources across the continuum of care. This more accurate and complete picture of patient health drives better health outcomes for these programs and enables their participants to live longer and healthier lives, with lower health care costs. As many disease management programs and companies are hired by health insurance payers for improved outcomes, the two entities have similarly aligned values and goals as described in the first embodiment described above.

A further embodiment of data automation can give access to complete and accurate health information to health care providers and health insurance payers for clinical decision support and predictive disease and epidemiology programs based on analysis of clinical data and clinical outcomes over a population of data. The solution connects to and aggregates information from EHRs, HISs, LISs and other clinical data sources to feed client analytic tools that identify adverse health indicators across a population according demographics including but not limited to patient or population geography, age, race, and others. Preemptively identifying adverse health indicators will enable private and public health providers to contain costs through preventing or containing an epidemiological situation.

Moreover, an embodiment of data automation can enable laboratories to connect their disparate LISs for the purpose of sending lab orders and results among each other, as labs often rely on each others' reference labs, according to specialty, geography, order volume and lab capacity. The solution connects the LIS of a large, national clinical lab with reference labs that are locally based, to handle order spill over and specialty orders. The orders and results are transmitted automatically to and from each system, into and out of each unique data standard, and matched with the PHI record in each system.

Another embodiment of data automation can provide health information from EHRS, LISs and HISs to health care providers and health insurance payers for the purpose of incorporating the data with pharmaceutical data, including claims, to enable them to run analysis and cross reference data. Clinical results and health information incorporated with pharmaceutical records, including claims, will enable heath insurance payers and health care providers to better understand the outcomes of their members, understand the success of various pharmaceutical courses of treatment, and be able to utilize this data to improve their health coaching and/or health consulting efforts by having a better understanding of their members health.

Furthermore, an embodiment of data automation can provide health coaching or health consulting programs clinical data on their insured members to monitor and enhance the overall understanding of member health. This includes tracking trends in their health which may lead to chronic diseases, cross referencing pharmaceutical data to assist members in their efforts to take medication as prescribed, and to assist in the overall effort to improve member's health thru life changes or moderation.

Another embodiment of data automation can provide clinical data to clinical laboratories specializing in the study of diseases related to public health and predictive epidemiology. Accurate and anonymous data will enable clinical laboratories to further their studies of diseases with a current view of large populations, track trends across large populations and use analysis to identify and predict health trends. Further, the solution can provide a method of transfer for individuals or specific organizations, hospitals, or Universities working in conjunction with specialized laboratories by offering their data to the specialized lab for studies related to disease.

Also, an embodiment of data automation can provide clinical data and other data from EHRs, HIS, and LIS for the purpose of reviewing best practices at hospitals, physician practices and laboratories. Utilizing clinical data can provide a more detailed view of the best practices and allows the reviewer to examine large blocks of data from various and disparate sources which is not readily accessible. Hospitals can monitor their own utilization rates, and this information can then be integrated into public health quality ratings.

Additionally, an embodiment of data automation can provide clinical data and other data from EHRs, HISs, and LISs to pharmaceutical companies for the purpose of tracking results, effects, or changes in health conditions of individuals who are taking a specific medication. Providing real time clinical data to pharmaceutical companies can provide these companies with a data set that provides recent data on the results or outcomes from taking medications; this improves the timing of results and detail of results and will improve the pharmaceutical companies understanding of their products.

Another embodiment of data automation can provide historical clinical data and other data from EHRs, HISs, and LISs to hospitals or physician groups whereby the hospital or physician group does not have historical clinical data and other data for patients that have joined their network or practice. This data could be transferred into the HIS or EHR from EHRs, HISs, or LISs to provide the hospital or physician with a better understanding of the patients health history.

A further embodiment of data automation can feed real-time data accurately into a system that generates alerts based on highly customizable parameters, to make the alerts as accurate as possible and minimize the negative behavioral impact of alerts generating too many false-positive results and being thereby deemed as largely unreliable. By aggregating very specific information into an alerts system that is finely tuned, data automation enables a smart alerts functionality to yield a more probabilistic view of the world and the measures necessary to be taken to mitigate an acute or dangerous situation.

Another embodiment of data automation can feed specific data in real time to graphical modeling tools that measure specific conditions based on sophisticated analyses for finely tuned and highly accurate, real-time calculi for strategic purposes. These include risk management systems, predictive analysis models and tools, business process and workflow modeling tools and other business intelligence tools.

Providers and payers in healthcare, both private and public, find data automation particularly useful and have enormous immediate benefit from the ability to access real-time clinical patient and population data for various sophisticate strategic analysis objectives. Beyond health care providers and payers, industries and business functions that have shown an interest in data automation include financial services for risk management, manufacturing for supply chain management, energy and utilities for monitoring and compliance, academic institutions, think-tanks and non-governmental organizations for research, and many others that will benefit from automating accurate access to data from disparate systems in real-time.

Significantly, the data automation process and system can be a software tool that collects data from disparate data sources and aggregates complex data forms into a useable form, for various strategic purposes. The data automation process and system can automate the process of connecting to any and all disparate data source systems, and then translate and transform and aggregate data into one, unified, usable data standard, which can be reported on, queried and/or transformed and transported into any data requesting or receiving system and in any data standard. The data automation process and system can work with infinitely large volumes of data, and complex data sets.

Also, the data automation process and system can process data in near real-time, with overall system processing speed dependent largely on the frequency with which data source systems update and refresh themselves. The data automation process and system can be designed to enable infinite flexibility, to accommodate changing systems environments and data structures and standards. Furthermore, the data automation process and system enables sophisticated analytics of very large, dynamic and complex data sets that would otherwise be impossible to analyze through manual methods due to their size and cumbersome nature.

Desirably, the data automation process and system and the sophisticated analysis of the data it provides can yield entirely new perspectives on and insights into the complexities of the world, society and business. Moreover, the data automation process and system can be based on a “hub-and-spoke” system architecture, with each unique data source, data requesting and data receiving system representing a “spoke” or node system in the overall architecture, which interact with the central processor as the “hub” of the system. Also, the data automation process and system can index the location of each datum on each system and a data locator, which can be automatically updated as data is added and/or data and locations change, in a master data index. Furthermore, the data automation process and system can hold the data it processes, including tracking the processes used to transform and standardize it, in a data warehouse. Moreover, the data automation process and system can be designed to enable “plug-and-play” installation and implementation within the network of each data source system and requesting data receiving system.

The data automation process and system can automate the system connectivity process, requiring minimal manual review and revision effort. The data automation process and system can also “learn” from any manual effort required in connecting each system, to automate the same or similar such steps in the connecting process thereafter. The data automation process and system can further collect each system's data and index all data locations as data are added or changed in a file that resides within the network of each system.

If desired, the data automation process and system can give immediate alerts of “exceptions” in the transfer and mapping processes, which can be manually remediated initially, and then incorporated into automated process moving forward. The data automation process and system can also provide alerts when data cannot be automatically identified, and requires manual review.

The data automation process and system can encrypt and securely transfer data and its indexed source location to queue tables for central processing in the data warehouse. The data automation process and system can further decrypt data stored in the queue tables and standardize the data by replacing local client data identifiers with its own standardized identifiers, which also cleans up irregularities in the data format. Also, the data automation process and system can eliminate the errors and omissions inherent in the manual process of capturing and delivering large sets of complicated data.

The improved data automation process, can comprise: providing a network comprising: (1) an electronic communications system comprising an electronic communications device; (2) a data source system comprising at least one electronic data source device providing a database having electronic source data; and (3) a data requesting system comprising an electronic data requesting device. The improved data automation process, can further comprise: electronically encrypting at least some of the electronic source data from the electronic data source device; retrieving the encrypted source data in the electronic communications device; decrypting the encrypted source data in the electronics communications device; electronically standardizing the decrypted source data into universal standardized data in the electronic communications device; electronically storing the universal standardized data in the electronic communications device; and transmitting at least some of the universal standardized data from the electronic communications device to the electronic data requesting device. The electronic data requesting device can be the same as or different from the electronic data source device.

The improved data automation process can also comprise electronically indexing, parsing, classifying and/or categorizing the universal standardized data in the electronic communications device. In the illustrative embodiment, the electronics communications device can electronically convert or format the universal standardized data into formatted data that can be read and processed by the electronic data requesting device. The electronics communications device can transmit the requested formatted data to the electronic data requesting device.

Preferably, the improved data automation process can provide an electronic audit trail of the encrypting, retrieving, decrypting, standardizing, storing and transmitting.

The source data can comprise one or more of the following: personal health information (PHI), electronic medical records (EMR), electronic health records (EHR), diagnostic information, health insurance information, medical claims, clinical data, clinical trials, laboratory test results, medical test results, genetic testing results, laboratory information, disease information, treatment data, chronic disease data, medical information, medical condition information, public health information, epidemiological information, pharmaceutical data, demographic information, geographical information, identifying data, age, race, first name, last name, legal name, social security number, identification number, passport information, driver's license, personal information, date of birth, biometric data, behavior information, psychological information, patient information, patient conditions, patient temperature, patient blood pressure, patient allergies, patient medical history, patient treatment, patient prognosis, patient diagnosis, patient allergies, patient medical injections, patient shots, patient prescribed medicine, pulse readings, blood type, blood analysis, fingerprints, hair color, eye color, eye scan, cornea scan, iris scan, retina scan, eye pressure, finger prints, teeth identification, dental records, DNA information, level 7 (HL7 v2.x) data, ventilator records, LOINC coded data, ICD-9 coded data, ICD-10 coded data, and combinations of any of the preceding source data, business information, business data, academic information, educational data, government information, compliance information, and research data.

The source data system can be operable for one or more of the following sources: a hospital, medical center, healthcare facility, healthcare provider, medical office, medical personnel, physician, physician specialist, dentist, podiatrist, veterinarian, U.S. public health official, nurse practitioner, certified registered nurse anesthetist, clinical nurse specialist, medical psychologist, physician assistant, clinic, laboratory, government agency, pharmacist, pharmacy, pharmaceutical company, health insurance company, actuary, health plan provider, insurer, financial institution, service provider, utility company, oil company, gas company, waste disposal company, recycling company, supplier, business, wholesale, retailer, planner, library, school, college, and university.

The standardized data can be used for one or more of the following: medical diagnosis, medical analysis, disease management, healthcare management, healthcare risk management, emergency management, public health surveillance and monitoring, predictive epidemiology systems, health care insurance, risk management, insurance, financial services, supply chain management, monitoring, compliance, energy management, utility management, education, research, statistical analysis, strategic planning, predictive analysis, business modeling, business management, business, and combinations of the preceding uses.

The network can comprise: a global communications network, internet, wide area network (WAN) local area network (LAN), WiFi network, Bluetooth network, and combinations of any of the preceding networks.

The electronic communications device can comprise: a wired electronic communications device, a wireless electronic communications device, central processing unit (CPU), server, microprocessor, lap top computer, desk top computer, electronic computing device, computer, electronic device radiotelephone, cellular (cell) phone, mobile phone, smart phone, qwerty phone, flip phone, slider phone, android phone, tablet phone, camera phone, clamshell device, portable networking device, portable gaming device, electronic communications device, personal digital assistant (PDA), wireless e-mail device, a two way pager, internet communication device, tablet device, android tablet, ipod, ipad, kindle, electronic reading device, electronic photo frame, digital photo frame, digital picture frame, video player, audio player, electronic calculator, electronic monitor, blackberry, tablet device, video device, electronic processor, mobile computing device, computer, netbook, data sharing device, wireless device, handheld electronic communications device, global positioning system (GPS), navigation device, transmitting device, electronic receiving device, electronic planner, workout planner, electronic calendar, scheduling device, music player, MP3 player, performance monitor, incoming call notifier, statistical storage device, data storage device, information storage device, cadence sensor, goal setting device, fitness tracker, exercise monitor, sports monitor, workout frequency monitor, downloadable device, Bluetooth compatible device, data sharing device, a hand held electronic device, or combinations of any of the preceding.

The improved data automation process as recited in the patent claims has produced unexpected surprisingly good results.

A more detailed explanation of the invention is provided in the following detailed descriptions and appended claims taken in conjunction with the accompanying drawings.

### BRIEF DESCRIPTION OF THE DRAWINGS

FIG. 1 is a process flow diagram of part of a data automation process and system and illustrating various components in accordance with principles of the present invention.

FIG. 2 is a process flow diagram of part of a data automation process that can be used for matching a personal health information (PHI) file in the master patient index (MPI) and PHI tables in accordance with principles of the present invention.

FIG. 3 is a process flow diagram of part of a data automation process that can be used for formatting and pushing data from the PHI tables to a data source in accordance with principles of the present invention.

FIG. 4 is a diagrammatic view of part of a network with an electronic communications system comprising a central processing unit (CPU), interactive communication devices and related equipment in accordance with principles of the present invention.

FIG. 5 is a perspective view of a handheld electronic communications device in accordance with principles of the present invention.

### DETAILED DESCRIPTION OF THE INVENTION

The following is a detailed description and explanation of the preferred embodiments of the invention and best modes for practicing the invention.

The PHI transfer service can be a Windows-based service that can be installable on computers, and resides on a computer within the network of the incoming data source. This service monitors a set of folders on the network for new files, to transmit them to the data gateway for processing. Its purpose is transferring files from the incoming data source to the data gateway. Compatible systems can include Windows XP SP3, Vista Pro and above, Windows 7 Pro and above, Windows 2003 server, Windows 2008 server.

The service can have the following structure for the application settings for Incoming Sources (Block): Incoming Source (Block); User Name (Attribute); Password (Attribute); Folders (Block); ErrorFolder (Attribute); Folder (Block); Folder Path (Attribute); File Extension (Attribute); Copy Folder (Attribute-optional) and for Log: Use (Attribute)—Event (event log) or TextFile (if Text File, must include folder); and Folder—folder for text file.

For each incoming source, there can be a separate user name and password. This allows one service to monitor several different incoming data sources at the same time. Each data source could have more than one folder to monitor. The folder path is not recursive. To define subfolders, additional paths must be declared.

On startup, the service can read the settings file and imports the settings. The service can make a single call for each incoming source to the data gateway to verify the user name and password. On failure, the service can write to the event log, otherwise it can begin to watch the defined folders. If one of the folders does not exist, it can create that folder.

When a new file is found that matches the extension (wildcards are permitted), that file can be read as plain text. The service calls the inbound data function of the data gateway with the user name, password, and encrypted text of the file. All text is encrypted with a 2-way custom encryption structure. The service can respond with a success or failure flag of the transmission. This is written to the event log. If the gateway returns a success the following is performed: if the folder has a copy folder defined, that file is then be copied to the folder. The file can finally be deleted from the original folder. If the gateway returns a failure, the file can be moved to the error folder.

The service can continually call a function at the data gateway every 5 minutes with the user name and password. These calls serve the purpose of informing the data gateway that the service is still running and to let the service know if the credentials are valid. Only on a failure is this event written to the event log.

Upon this, the PHI transfer service can move files to the data gateway. The data gateway can be an ASP.Net web service application that will reside in the central infrastructure. This is the only point of contact for any inbound data. The data gateway must run on an SSL connection for security purposes.

The validate credentials function can take in a user name and password. This is validated against the data warehouse to ensure that the data source is both valid and active. If the data source is valid, active, and the password matches, a success flag (true) is returned, otherwise a fail flag (false) is returned. This function can also populate a log table in the warehouse on any successful connections that include the data source identification, date and time of connection, and IP address of the calling service. On any failures, this function can write to an error table with the user name passed, the reason for the failure (invalid data source, invalid password, etc.), the date and time, and the IP address of the calling service.

The inbound data function can take in a user name, password, and an encrypted text blob. First, the inbound data function performs the validate credentials function to ensure the user name and password is valid. If it is valid, the function populates a queue table of inbound messages. This queue table has the encrypted data, the data source identification, date and time of the message, and a processed flag (which is set to false by default).

Upon this, files can be transferred to the data warehouse. The data warehouse houses all the data required for the system to function and aggregate data. The data schema can be customized according to project needs for each embodiment and client implementation, and is designed over the course of the first iteration of the project.

The data source tables can hold the information about each data source, user names, and passwords. The PHI tables can hold all the normalized PHI data. This includes the Master Patient Index (MPI) and the specific patient data. For each new patient data, the data can be linked to the original data source and message for the purpose of security (regarding viewer permissions for that data).

The ETL tables can hold all the incoming messages, and data translation and standardization rules. The administrative tables can hold all log data, error messages, and other high level system settings. This set of tables includes all users that can access the web based query tool and what data sources they have access to.

The ETL process can be a Windows Service that will reside in the central system. This process can monitor the incoming queue for new messages and process them accordingly. For each incoming message, the ETL process can perform the following steps: Message Decrypter decrypt the original message; message standardizer identifies any custom translations of the file for the incoming system to standardize the file format and perform those translations (e.g.—each lab's test codes will map to the medical lab standard (LOINC) Codes) and Standardizes any identifiers in the file based on the internal standards; message normalizer breaks the message into the normalized format to populate the data warehouse; master patient index performs a master patient index (MPI) match based on the patient information with the internal MPI data, if there is a match, use the MPI ID for the matching patient in the warehouse, if there is not a match, create a new patient in the MPI or create an alert to manually review and remediate the exception (see MPI Matching Process for details); and warehouse loader inserts the data into the data warehouse.

During the process, if there is any failure, the reason can be written to the error table with the ID for the incoming message. The incoming message can be marked as processed, but an additional field in the incoming messages table (MessageError) is set to true to identify that there was an error and the message was not migrated into the warehouse.

The MPI matching process can require a minimum of two of the following fields to be a match to consider the message as matching a patient in the database: Last and First Name; Date of Birth; Social Security Number (only if the number is considered to be a valid social security number); or internal ID (in combination with the data source).

If there is a match, the data can use the MPI ID that the system creates. If there is no match, settings can be checked for the data source. If the data source allows for automatic creation of new patients then a new patient can be created. If the system does not, a new patient can be created but marked as “Requiring Review” (a Boolean field) and an alert can be generated. This field can trigger a report to allow someone to either manually match the patient or to mark the patient as new.

The Master Patient Index (MPI) can be a set of tables defined in the data warehouse that allow for the aggregating of data of many different sources but keeping a single patient list. The MPI can be comprised of two tables. The Master Patients table can have one record for each distinct patient in the system. The Patient Demographics table can hold an entry for each data source that reports data for a patient. This table can hold the specific demographics we receive from that data source. This can also hold the Internal ID for that patient from the incoming message. If an incoming message matches a record in this table according to the MPI matching algorithm, but has different data for the other fields, the system can update those fields (with the exception that a field will not be made blank once it is populated).

The web based query tool can be an ASP. Net web application that will allow users to query on a patient and pull up all their PHI data. Users to this system can manage the basic administration system. When a user first comes to the system, they can log in with their user name and password. Once inside, they can have a menu of reports they can perform. The patient report can allow and authorize a user to search for a patient and then view all the PHI data that they are permitted to see. The user can enter in two or more of the following fields: first name; last name; date of birth; social security number; address; city; state; postal code; country, phone number; and data source which can comprise and be viewable as a drop down list or menu of data sources which can be accessible to an authorized the user.

When a user submits the data, the system can search the patient demographics table for a match. It only searches rows for data sources the user has access to. If it finds a match, it returns the patient information and the MPI ID (from the master patient table) for that patient. If the system returns more than 25 possible matches, the system returns a message saying the search returned more than 25 results and will require the user to enter more information. Each field is treated as a “Like” search with the exception of Data Source (Date of Birth will be 3 fields, Month, Day, and Year). Once a list of 25 or less matches is found, the user can be presented the list with a link to view the patient data.

The patient data screen can show the PHI data for an individual patient. This data includes all records from data sources where the user has permissions. If there are additional sources that the user does not have permissions, a message can appear on the bottom of the screen informing the user that there is more data that they do not have access to and telling them to contact the system administrator for more information.

This screen can show the following information: patient demographics, including all data from the matching for in the patient demographics table; additional demographics, including additional rows of patient demographics from other data sources that the user has access to; test results, showing all lab tests performed and the results using our standardizations (most recent first); vital statistics, showing the vital statistics for that patient over time (most recent first); past diagnosis codes, showing all past diagnosis codes for that patient over time (most recent first); and notes, showing all notes for this patient over time (most recent first).

The basic administration site can allow system administrators to manage the system settings through a web interface. The basic administration site can have the following functions: data source management to create and manage data sources in the system; query tool user management to create and manage users and data source permissions; error log to show the error log; error messages management to show messages with errors, the unencrypted text, and allows a user to edit the message, which creates a new message in the system with the new encrypted text and can link it to the original message through a supporting table; client status to show the list of data sources and whether they are currently up; incoming data report to show a report for each data source of the number of messages during a given time period; master patient index report to show the number of unique patients in the system and total patient demographics by data source; and PHI data report to show the total number of patients and data points in the system as a whole and by data source.

Once data is aggregated into the PHI tables, data can be formatted for a push into external data sources utilizing the same infrastructure that pulled the data into the system. Data can be selected from the PHI tables using the data query tool. This tool selects all information required by the receiving data source and performs and aggregation or analysis. Data is then formatted by the data formatter. This puts the data is a format that the destination can interpret (e.g. HL7, CSV, table structure, etc.).

Once formatted, the data can be moved into a queue table where it is eventually picked up by the destination. Periodically, the client transfer service makes a request of the data gateway for any pending data. The data gateway checks the queue for any pending data. Data is transferred through the gateway to the client transfer service. The client transfer service saves the data in the approved format of the destination. The data is transferred into the data repository of the destination as the destination system periodically refreshes.

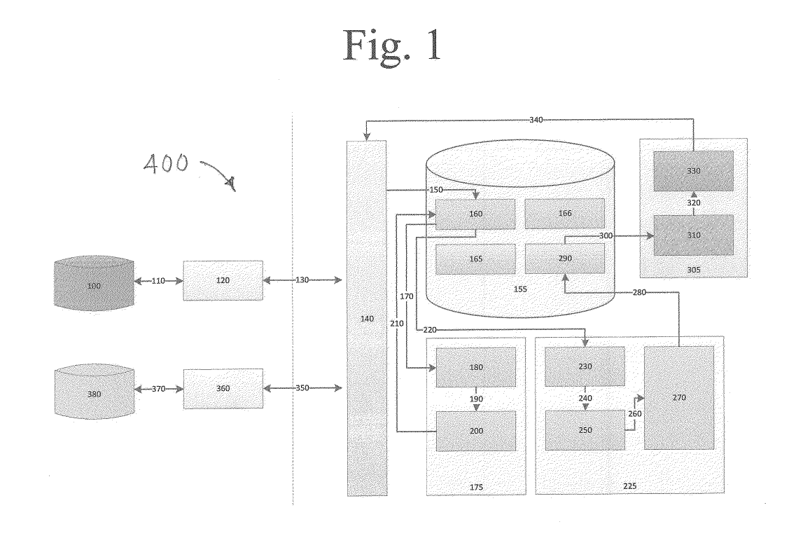

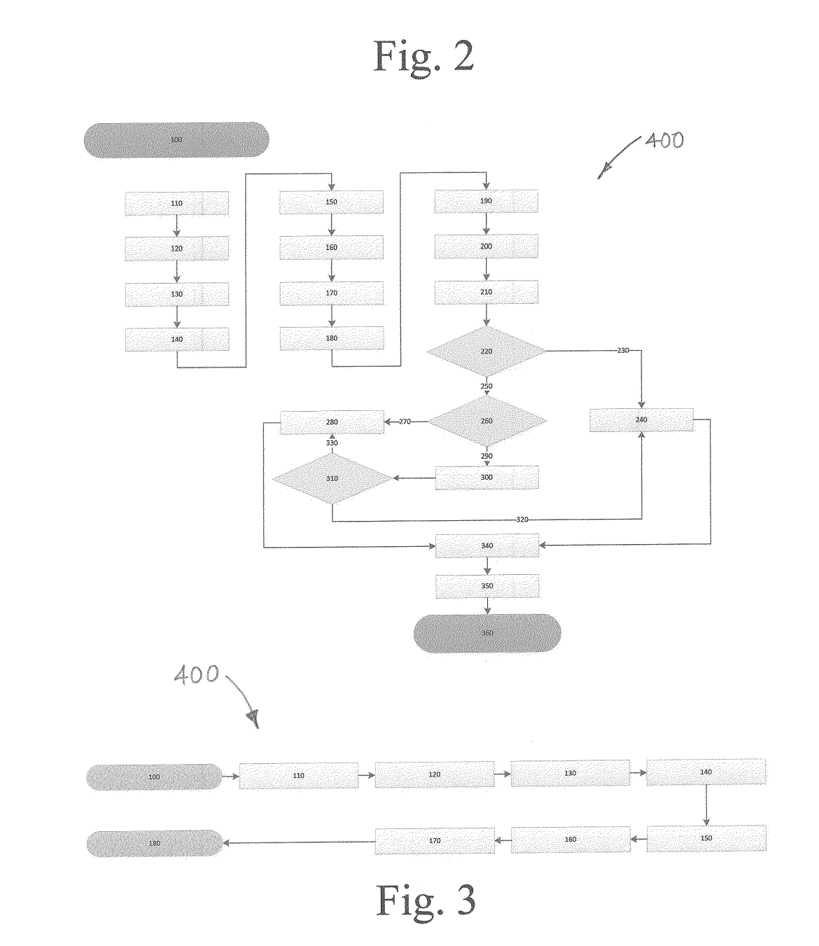

As shown in FIGS. 1-3, there is provided a client A data source system 100 which can comprise any source of transactional or aggregated data in a format such as a relational database, spreadsheet, flat file, or other structured data. An electronic health records (EHR) module 110 comprising HER software can prepare data to be transmitted and pass it to the client transfer service module 120 in an approved manner. The client transfer service module can provide client A transfer service comprising a software application can read the data source and transmit the data to a central data gateway for processing. A client transfer service 130 can encrypt and transfer the data to the data gateway module 140 within the centralized data center. The data gateway module can comprise a centralized application that is able to accept various forms of data from a transfer service and prepare it for internal processing. The data gateway 150 can store the incoming data in a queue table for processing inside the data warehouse.

A data warehouse module 155 (FIG. 1) can comprise a relational database structure that cam stores transactional data and the aggregated views of the transactional data. The data warehouse module can comprise a module comprising queue tables 160 which can provide a database table structure that stores incoming data from the data gateway in preparation for further processing. The data warehouse module can also comprise a module comprising data source tables 165 that can record location information of source data which comprises tables that hold information regarding the originating source of the data, associated attributes of the data, and necessary details required for additional processing. The data warehouse module can also comprise an exchange, transform, load (ETL) table 166 which can record transformation information of source data—tables that hold various processing instructions for data processing dependent on requirements set forth in the data source tables. A message decrypter 170 can retrieve or pickup a new message from the queue table and decrypts the message.

A message standardization process module 175 (FIG. 1) can comprise an internal process that can take incoming data in any structured format and converts it to a standardized format utilized in the data warehouse. The message standardization process module can comprise a message decrypter 180 comprising a process that can decrypt incoming data into standard ascii or Unicode formats. The decrypted message 190 can be sent or passed to the message standardizer 200 which can replace any local identifiers with standardized identifiers. The process can also clean up any irregularities in the file format. The message standardizer can comprise an internal process that retrieves or takes incoming data in any structured format and converts it to a standardized format utilized in the data warehouse. The standardized message 210 can be transferred back to the queue table to await normalization processing. A message normalizer 220 can retrieve and pickup the pending standardized message and separates the message into the distinct data components.

In the data automation process and system, a message normalization process module 225 (FIG. 1) which can comprise a message normalizer 230 that can provide a process that can take any identifying data and change identifiers from local system values to standard values in the data warehouse. A master patient processor 240 can perform patient matching algorithms to associate the incoming data with a patient in the database of the electronics communications system. Any matches can aggregate the data under one individual. New patients will also be generated if necessary. The message normalization process module can comprises a master patient processor module 250 which can comprise a process that creates a single reference for all patients from all systems and ensures each incoming data point uses the same identifiers for that patient. The process can use various matching algorithms to determine the patient and either assign it a new number or match it to an existing patient. A warehouse loader 260 can take or retrieve the normalized message with the appropriate patient identifier and can load the patient health information (PHI) tables. The message normalization process module can comprises a warehouse loader module 270 which can provide a process that takes the completely standardized data and can load it into the aggregated data warehouse. The patient health information 280 can be aggregated inside the PHI data tables.

The data automation process and system can also provide a module comprising PHI Data Tables 290 (FIG. 1) comprising patient health information tables which can store patient information including demographics, vital statistics, tests, diagnoses, and other relevant medical data. For data being transmitted back to an external data source 300, the data query tool inside the data request processor can extract the data from the PHI data table and transmit it to the data request processor 305.

The data request processor can comprise a data query tool 310 (FIG. 1) which can comprise a user interface tool that allows a user to design a query against the data warehouse for retrieving various data sets. A data formatter 320 can take the queried data and repackage it in a format that the receiving data source device can process. The data formatter module 330 can comprise a tool that can take a data set and reform it based on the destination data source requirements. The data can be transferred through the data gateway 340 for retrieval. The data gateway can also encrypt the data and transfer it to the appropriate client transfer service.

The data automation process and system can also provide a client B transfer service module 360 as well as an a client transfer service 370 which can store the data locally in a format the receiving data source can process. The data automation process and system can further provide a client B data receiving system 380.

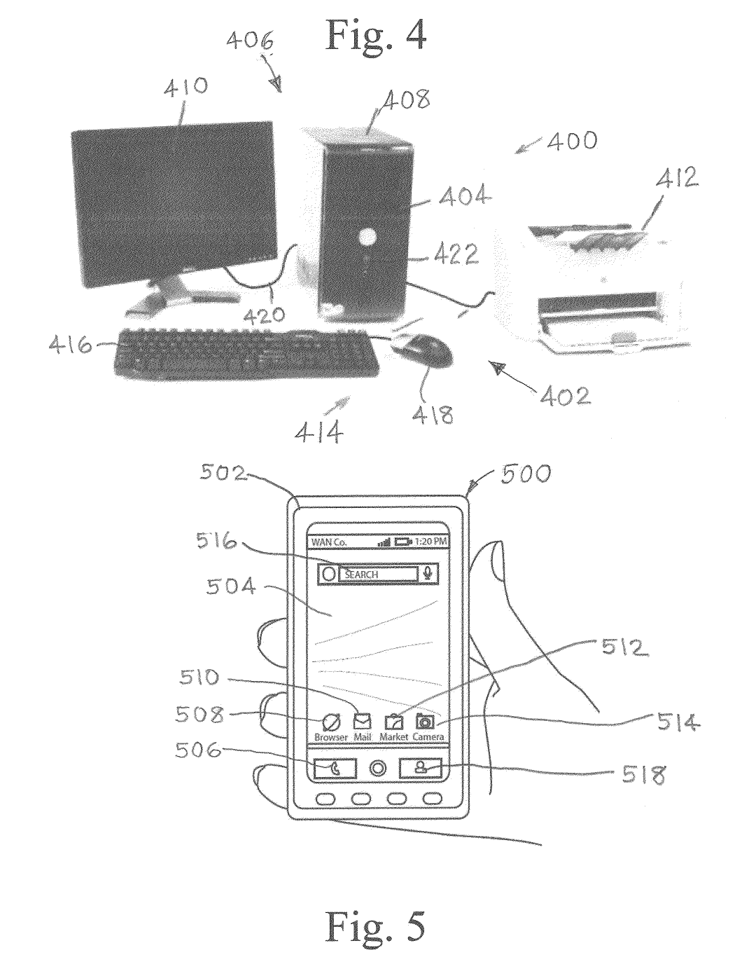

As shown in FIG. 4 of the drawings, an electronic communications network 400 can comprise an electronic communications system 402 with an electronic communications device 404, such as a desktop computer 406 providing a central processing unit (CPU) with a hard drive 408 which provides data storage. The CPU can have various related equipment and components including an electronic display screen 410 such as a monitor, printer 412 and one or more interactive communications devices comprising electronic inputting devices 414, such as a keyboard 416 or electronic mouse 418. The CPU can be hard wired by a bundle of wires or cable 420 and/or or in wireless communication, such as by Bluetooth, via an antenna 422 with one or more related equipment and components, e.g. the screen, printer, and interactive communications device. If desired, the screen can be separate from and/or operatively associated and connected to the CPU.

As shown in FIG. 5, the electronics communications device of the electronic communications system in the network can comprise a mobile handheld electronic communications device 500. The electronic communications device can be operable for mobile phone communications. The mobile handheld electronic communications device can be moveable and pivotable from a landscape orientation mode (landscape mode or landscape orientation) to a portrait orientation mode (portrait mode or portrait orientation) and vice versa. The mobile electronic communications device can have a display module and a chassis which can comprise a modular housing assembly with a modular housing 502 to securely hold the display module. The display module can comprise an electronic visual display providing an electronic display screen 504 for displaying data, text graphics, images or other indicia. The electronic visual display can comprise an elongated, generally rectangular display lens. The display lens can comprise a user interface (UI) and can have a touch sensitive haptic elongated front lens surface. The display lens can comprise: a glass lens, transparent lens, touch sensitive lens, haptic lens, screen, impact-resistant screen, display screen, touchscreen, screen with an accelerator, monitor, light emitting display, or combinations of any of the preceding. The touch sensitive surface of the lens can have touch sensors which generate a signal in response to a manually engageable haptic input from a user when the user touches the touch sensitive surface of the lens with a finger. Touch sensors can be located behind the front surface of the lens or behind the back surface of the lens. The user interface and a display module can comprise a light emitting display for emitting light forming an image on the lens in response to the signal. The display module can also have piezoelectric elements that can provide haptics with direct piezoelectric bending action for allowing substantial transfer of mechanical vibration energy.

The mobile electronic communications device can have various control buttons including volume control buttons and operating keys. The control buttons can include an on-off power button, a sleep mode button, an airplane mode button, or combinations thereof. The mobile electronic communications device can also include various program applications (APs) capable of operating at normal or rapid data rate communications. The applications can be represented by different icons. Examples of such applications can include, but are not limited to: a cellular telephone application 506, mobile web browser application 508, e-mail application 510, stock market and/or internet shopping application 512, camera application 514, internet search application 516, and/or social media application 518.

The improved data automation process can comprise: (a) providing an electronic communications network comprising an electronic communications system with an electronic communications device and an electronic display screen that is operatively connected to the electronics communications device; (b) at least one healthcare data source system comprising an electronic healthcare data source device providing a health care database having electronic health care-source data in a structured format; and (c) a healthcare data requesting system comprising an electronic healthcare-data requesting device. The healthcare data source system can be different than the electronic communications system and the healthcare data requesting system can be different than the electronic communications system and the healthcare data source system. The electronic healthcare data source device can be remotely positioned and spaced from the electronic communications device. Furthermore, the electronic healthcare-data requesting device can be remotely positioned and spaced from the electronic communications device and the electronic healthcare data source device.

The improved data automation process can further comprise the following: electronically encrypting at least some of the electronic health care-source data from the electronic healthcare data source device; remotely accessing and retrieving the encrypted electronic health care-source data to the electronic communications devices; decrypting the encrypted electronic health care-source data in the electronics communications device; electronically converting, formatting and standardizing the decrypted electronic health care-source data into standardized healthcare data in a standard format in the electronic communications device; electronically storing the standardized healthcare data in the electronic communications device; displaying and viewing at least some of the standardized healthcare data on the electronic display screen; electronically converting and formatting the standardized healthcare data with the electronic communications device into electronically readable healthcare data providing electronic requested healthcare data in a compatible format that the electronic data requesting device can electronically read and process; electronically encrypting the electronically readable healthcare data from the electronic communications device; transmitting the encrypted electronically readable healthcare data from the electronic communications device to the electronic data requesting device; and decrypting the encrypted electronically readable healthcare data in the electronic data requesting device.

In the illustrative embodiment, each of the devices (electronic healthcare data source device, electronic communications device, and electronic data requesting device) can have an electronic gatekeeper providing a gateway for permitting only authorized users for accessing, receiving or transmitting healthcare data to the device.

The improved data automation process can also comprise: electronically processing the electronic healthcare source data in the electronic communications device, the electronic processing by indexing, parsing, categorizing, classifying, itemizing, separating, comparing, differentiating, collating, calculating, providing a data table, and/or generating a report, or combinations thereof The improved data automation process can further comprise: electronically identifying and matching data corresponding to a patient in the electronic communications device; electronically normalizing and changing patient identifiers to a standard value for the patient; and providing an electronic audit trail of the encrypting, retrieving, decrypting, converting, standardizing, storing and transmitting.

Furthermore, the improved data automation process can include: inputting supplemental data into the electronic communications device with an electronic inputting device, such as: a wireless electronic inputting device, wired inputting device, touch screen, touch pad, screen pad, keypad, keyboard, wireless keyboard, keys, buttons, electronic mouse, wireless mouse, audible input device, transmitter, or combinations thereof The data can be display on an electronic display screen such as: a monitor, touch screen, electronic visual screen, impact-resistant screen, screen with an accelerator, light emitting display, or touchpad.

The healthcare source data can be from one or more of the following: personal health information (PHI), electronic medical records (EMR), electronic health records (EHR), diagnostic information, health insurance information, medical claims, clinical data, clinical trials, laboratory test results, medical test results, genetic testing results, laboratory information, disease information, treatment data, chronic disease data, medical information, medical condition information, public health information, epidemiological information, pharmaceutical data, demographic information, geographical information, identifying data, age, race, first name, last name, legal name, social security number, identification number, passport information, driver's license, personal information, date of birth, biometric data, behavior information, psychological information, patient information, patient conditions, patient temperature, patient blood pressure, patient allergies, patient medical history, patient treatment, patient prognosis, patient diagnosis, patient allergies, patient medical injections, patient shots, patient prescribed medicine, pulse readings, blood type, blood analysis, fingerprints, hair color, eye color, eye scan, cornea scan, iris scan, retina scan, eye pressure, finger prints, teeth identification, dental records, DNA information, level 7 (HL7 v2.x) data, ventilator records, and combinations of any of the preceding source data.

The healthcare-source data system can be operable for one or more of the following sources: a hospital, medical center, healthcare facility, healthcare provider, medical office, managed care facility, medical personnel, physician, physician specialist, dentist, podiatrist, veterinarian, U.S. public health official, nurse practitioner, certified registered nurse anesthetist, clinical nurse specialist, medical psychologist, physician assistant, clinic, paramedic, emergency medical technician, ambulance technician, laboratory, government agency, pharmacist, pharmacy, pharmaceutical company, health insurance company, actuary, claim system, health plan provider, insurer, laboratory information management system (LIMS), laboratory information system (LIS), laboratory management system (LMS), electronic prescribing system (E-Rx), radiology information system (RIS), hospital information system (HIS), health care information system, medical picture archiving and communications system (PACS), medical imaging system, digital imaging and communications in medicine, level 7 (HL7 v2.x) data standard system, ventilator records system, point of care (POC) system, care management system, cardiographs, respirator, medical device, healthcare effectiveness data and information set (HEDIS) system, health maintenance organization (HMO), center for Medicare and Medicaid services (CMS), agency for healthcare research and quality (AHRQ), clinical information system (CIS), patient data management system (PDMS), emergency management information system (IMIS), geographical information system (GIS), center for disease control and prevention (CDC), and health insurance portability and accountability act (HIPAA) eligibility transaction system (HTS),

The standardized healthcare data can be used for one or more of the following: medical diagnosis, medical analysis, disease management, healthcare management, healthcare risk management, emergency management, health care insurance, public health surveillance and monitoring, or predictive epidemiology systems.

The electronic communications network can comprise: a global communications network, internet, wide area network (WAN) local area network (LAN), WiFi network, Bluetooth network, or combinations of any of the preceding networks.

In the illustrative embodiment, each of the devices (electronic healthcare data source device, electronic communications device, and electronic data requesting device) can comprise one or more of the following: a wired electronic communications device, a wireless electronic communications device, central processing unit (CPU), server, microprocessor, lap top computer, desk top computer, electronic computing device, computer, electronic device radiotelephone, cellular (cell) phone, mobile phone, smart phone, qwerty phone, flip phone, slider phone, android phone, tablet phone, camera phone, clamshell device, portable networking device, portable personal digital assistant (PDA), wireless e-mail device, internet communication device, tablet device, android tablet, ipod, ipad, kindle, electronic monitor, blackberry, tablet device, video device, electronic processor, mobile computing device, computer, netbook, data sharing device, wireless device, handheld electronic communications device, data sharing device, and a hand held electronic device.

Although embodiments of the invention have been shown and described, it is to be understood that various modifications, substitutions, and rearrangements of parts, components, and/or process (method) steps, as well as other uses of the data automation process and system can be made by those skilled in the art without departing from the novel spirit and scope of this invention.

What is claimed is:

1. A data automation process, comprising the steps of:
providing a network comprising
an electronic communications system comprising an electronic communications device;
a data source system comprising at least one electronic data source device providing a database having electronic source data; and
a data requesting system comprising an electronic data requesting device;
electronically encrypting at least some of said electronic source data from said electronic data source device;
retrieving said encrypted source data in said electronic communications devices;
decrypting said encrypted source data in said electronics communications device;
electronically standardizing said decrypted source data into universal standardized data in said electronic communications device;
electronically storing said universal standardized data in said electronic communications device; and
transmitting at least some of said universal standardized data from said electronic communications device to said electronic data requesting device.

2. A data automation process in accordance with claim 1 including electronically indexing said universal standardized data in said electronic communications device.

3. A data automation process in accordance with claim 1 including electronically parsing and/or electronically classifying said universal standardized data in said electronic communications device.

4. A data automation process in accordance with claim 1 including electronically categorizing said universal standardized data in said electronic communications device.

5. A data automation process in accordance with claim 1 wherein said electronic data requesting device is the same as or different from said electronic data source device.

6. A data automation process in accordance with claim 1 wherein:
said electronic data requesting device electronically reads and processes requestor formatted data; and
said electronics communications device electronically converts said universal standardized data into requested formatted data and transmit the requested formatted data to said electronic data requesting device.

7. A data automation process in accordance with claim 1 including electronically transforming said universal standardized data into formatted data.

8. A data automation process in accordance with claim 1 including providing an electronic audit trail of said encrypting, retrieving, decrypting, standardizing, storing and transmitting.

9. A data automation process in accordance with claim 1 wherein:
said source data is selected from the group consisting of: personal health information (PHI), electronic medical records (EMR), electronic health records (EHR), diagnostic information, health insurance information, medical claims, clinical data, clinical trials, laboratory test results, medical test results, genetic testing results, laboratory information, disease information, treatment data, chronic disease data, medical information, medical condition information, public health information, epidemiological information, pharmaceutical data, demographic information, geographical information, identifying data, age, race, first name, last name, legal name, social security number, identification number, passport information, driver's license, personal information, date of birth, biometric data, behavior information, psychological information, patient information, patient conditions, patient temperature, patient blood pressure, patient allergies, patient medical history, patient treatment, patient prognosis, patient diagnosis, patient allergies, patient medical injections, patient shots, patient prescribed medicine, pulse readings, blood type, blood analysis, fingerprints, hair color, eye color, eye scan, cornea scan, iris scan, retina scan, eye pressure, finger prints, teeth identification, dental records, DNA information, level 7 (HL7 v2.x) data, ventilator records, LOINC coded data, ICD-9 coded data, ICD-10 coded data, and combinations of any of the preceding source data, business information, business data, academic information, educational data, government information, compliance information, research data, and combinations of any of the preceding source data;
said source data system is operable for a source selected from the group consisting of: a hospital, medical center, healthcare facility, healthcare provider, medical office, medical personnel, physician, physician specialist, dentist, podiatrist, veterinarian, U.S. public health official, nurse practitioner, certified registered nurse anesthetist, clinical nurse specialist, medical psychologist, physician assistant, clinic, laboratory, government agency, pharmacist, pharmacy, pharmaceutical company, health insurance company, actuary, health plan provider, insurer, financial institution, service provider, utility company, oil company, gas company, waste disposal company, recycling company, supplier, business, wholesale, retailer, planner, library, school, college, university, and combinations of any of the preceding sources; and
said standardized data is used for at least one use selected from the group consisting of: medical diagnosis, medical analysis, disease management, healthcare management, healthcare risk management, emergency management, public health surveillance and monitoring, predictive epidemiology systems. health care insurance, risk management, insurance, financial services, supply chain management, monitoring, compliance, energy management, utility management, education, research, statistical analysis, strategic planning, predictive analysis, business modeling, business management, business, and combinations of the preceding uses.

10. A data automation process in accordance with claim 1 wherein:
said network is selected from the group consisting of a global communications network, internet, wide area network (WAN) local area network (LAN), WiFi network, Bluetooth network, and combinations of any of the preceding networks; and
said electronic communications device is selected from the group consisting of: a wired electronic communications device, a wireless electronic communications device, central processing unit (CPU), server, microprocessor, lap top computer, desk top computer, electronic computing device, computer, electronic device radiotelephone, cellular (cell) phone, mobile phone, smart phone, qwerty phone, flip phone, slider phone, android phone, tablet phone, camera phone, clamshell device, portable networking device, portable gaming device, electronic communications device, personal digital assistant (PDA), wireless e-mail device, a two way pager, internet communication device, tablet device, android tablet, ipod, ipad, kindle, electronic reading device, electronic photo frame, digital photo frame, digital picture frame, video player, audio player, electronic calculator, electronic monitor, blackberry, tablet device, video device, electronic processor, mobile computing device, computer, netbook, data sharing device, wireless device, handheld electronic communications device, global positioning system (GPS), navigation device, transmitting device, electronic receiving device, electronic planner, workout planner, electronic calendar, scheduling device, music player, MP3 player, performance monitor, incoming call notifier, statistical storage device, data storage device, information storage device, cadence sensor, goal setting device, fitness tracker, exercise monitor, sports monitor, workout frequency monitor, downloadable device, Bluetooth compatible device, data sharing device, a hand held electronic device, and combinations of any of the preceding.

11. A data automation process, comprising:
providing a communications network comprising
an electronic communications system comprising an electronic communications device;
a data source system comprising at least one electronic data source device providing a data base having electronic source data in a structured format; and
a data requesting system comprising an electronic data requesting device;
electronically encrypting at least some of said electronic source data from said electronic data source device;
retrieving said encrypted source data in said electronic communications device;
decrypting said encrypted source data in said electronics communications device;
electronically converting, formatting and standardizing said decrypted source data into standardized data in a standard format in said electronic communications device;
electronically storing said standardized data in said electronic communications device;
electronically converting and formatting said standardized data with said electronic communications device into electronically readable data providing electronic requested data in a compatible format that said electronic data requesting device can electronically read and process;
electronically encrypting said electronically readable data from said electronic communications device;
transmitting said encrypted electronically readable data from said electronic communications device to said electronic data requesting device; and
decrypting said encrypted electronically readable data in said electronic data requesting device.

12. A data automation process in accordance with claim 11 wherein each of said devices has an electronic gatekeeper providing a gateway for permitting only authorized users for accessing, receiving or transmitting data to said device.

13. A data automation process in accordance with claim 11 including electronically processing said source data in said electronic communications device, said electronic processing comprises at least one processing step selected from the group consisting of: indexing, parsing, categorizing, classifying, itemizing, separating, comparing, differentiating, calculating, providing a data table, generating a report, and combinations of any of the preceding processing steps.

14. A data automation process in accordance with claim 11 including providing an electronic audit trail of said encrypting, retrieving, decrypting, converting, standardizing, storing and transmitting.

15. A data automation process in accordance with claim 11 wherein:
said source data is selected from the group consisting of: said healthcare source data is selected from the group consisting of: personal health information (PHI), electronic medical records (EMR), electronic health records (EHR), diagnostic information, health insurance information, medical claims, clinical data, clinical trials, laboratory test results, medical test results, genetic testing results, laboratory information, disease information, treatment data, chronic disease data, medical information, medical condition information, public health information, epidemiological information, pharmaceutical data, demographic information, geographical information, identifying data, age, race, first name, last name, legal name, social security number, identification number, passport information, driver's license, personal information, date of birth, biometric data, behavior information, psychological information, patient information, patient conditions, patient temperature, patient blood pressure, patient allergies, patient medical history, patient treatment, patient prognosis, patient diagnosis, patient allergies, patient medical injections, patient shots, patient prescribed medicine, pulse readings, blood type, blood analysis, fingerprints, hair color, eye color, eye scan, cornea scan, iris scan, retina scan, eye pressure, finger prints, teeth identification, dental records, DNA information, level 7 (HL7 v2.x) data, ventilator records, LOINC coded data, ICD-9 coded data, ICD-10 coded data, and combinations of any of the preceding source data, business information, business data, academic information, educational data, government information, compliance information, research data, and combinations of any of the preceding source data;
said source data system is operable for a source selected from the group consisting of: a hospital, medical center, healthcare facility, healthcare provider, medical office, managed care facility, medical personnel, physician, physician specialist, dentist, podiatrist, veterinarian, U.S. public health official, nurse practitioner, certified registered nurse anesthetist, clinical nurse specialist, medical psychologist, physician assistant, clinic, paramedic, emergency medical technician, ambulance technician, laboratory, government agency, pharmacist, pharmacy, pharmaceutical company, health insurance company, actuary, claim system, health plan provider, insurer, laboratory information management system (LIMS), laboratory information system (LIS),laboratory management system (LMS), electronic prescribing system (E-Rx), radiology information system (RIS), hospital information system (HIS), health care information system, medical picture archiving and communications system (PACS), medical imaging system, digital imaging and communications in medicine, level 7 (HL7 v2.x) data standard system, ventilator records system, point of care (POC) system, care management system, cardiographs, respirator, medical device, healthcare effectiveness data and information set (HEDIS) system, health maintenance organization (HMO), center for Medicare and Medicaid services (CMS), agency for healthcare research and quality (AHRQ), clinical information system (CIS), patient data management system (PDMS), emergency management information system (IMIS), geographical information system (GIS), center for disease control and prevention (CDC), health insurance portability and accountability act (HIPAA) eligibility transaction system (HTS), financial institution, service provider, utility company, oil company, gas company, waste disposal company, recycling company, supplier, business, wholesale, retailer, planner, library, school, college, university, and combinations of any of the preceding sources;
said standardized data is used for at least one use selected from the group consisting of: medical diagnosis, medical analysis, disease management, healthcare management, healthcare risk management, emergency management, public health surveillance and monitoring, predictive epidemiology systems, health care insurance, risk management, insurance, financial services, supply chain management, monitoring, compliance, energy management, utility management, education, research, statistical analysis, strategic planning, predictive analysis, business modeling, business management, business, and combinations of the preceding uses;
said network is selected from the group consisting of a global communications network, internet, wide area network (WAN) local area network (LAN), WiFi network, Bluetooth network, and combinations of any of the preceding networks; and
said electronic communications device is selected from the group consisting of: a wired electronic communications device, a wireless electronic communications device, central processing unit (CPU), server, microprocessor, lap top computer, desk top computer, electronic computing device, computer, electronic device radiotelephone, cellular (cell) phone, mobile phone, smart phone, qwerty phone, flip phone, slider phone, android phone, tablet phone, camera phone, clamshell device, portable networking device, portable personal digital assistant (PDA), wireless e-mail device, internet communication device, tablet device, android tablet, ipod, ipad, kindle, electronic monitor, blackberry, tablet device, video device, electronic processor, mobile computing device, computer, netbook, data sharing device, wireless device, handheld electronic communications device, data sharing device, a hand held electronic device, and combinations of any of the preceding.

16. A data automation process, comprising the steps of:
providing an electronic communications network comprising
an electronic communications system comprising an electronic communications device and an electronic display screen operatively connected to electronics communications device;
at least one healthcare data source system comprising an electronic healthcare data source device providing a health care data base having electronic health care-source data in a structured format, said healthcare data source system being different than said electronic communications system, and said electronic healthcare data source device being remotely positioned and spaced from said electronic communications device;
a healthcare data requesting system comprising an electronic healthcare-data requesting device, said healthcare data requesting system being different than said electronic communications system and said healthcare data source system, said electronic healthcare-data requesting device being remotely positioned and spaced from said electronic communications device and said electronic healthcare data source device;
electronically encrypting at least some of said electronic health care-source data from said electronic healthcare data source device;
remotely accessing and retrieving said encrypted electronic health care-source data to said electronic communications devices;
decrypting said encrypted electronic health care-source data in said electronics communications device;
electronically converting, formatting and standardizing said decrypted electronic health care-source data into standardized healthcare data in a standard format in said electronic communications device;
electronically storing said standardized healthcare data in said electronic communications device;
displaying and viewing at least some of said standardized healthcare data on said electronic display screen;
electronically converting and formatting said standardized healthcare data with said electronic communications device into electronically readable healthcare data providing electronic requested healthcare data in a compatible format that said electronic data requesting device can electronically read and process;
electronically encrypting said electronically readable healthcare data from said electronic communications device;
transmitting said encrypted electronically readable healthcare data from said electronic communications device to said electronic data requesting device; and
decrypting said encrypted electronically readable healthcare data in said electronic data requesting device.

17. A data automation process in accordance with claim 16 wherein each of said devices has an electronic gatekeeper providing a gateway for permitting only authorized users for accessing, receiving or transmitting healthcare data to said device.

18. A data automation process in accordance with claim 16 including:
electronically processing said electronic healthcare source data in said electronic communications device, said electronic processing comprises at least one processing step selected from the group consisting of: indexing, parsing, categorizing, classifying, itemizing, separating, comparing, differentiating, collating, calculating, providing a data table, generating a report, and combinations of any of the preceding processing steps;
electronically identifying, matching, and data corresponding to a patient in said electronic communications device;
electronically normalizing and changing patient identifiers to a standard value for the patient;
providing an electronic audit trail of said encrypting, retrieving, decrypting, converting, standardizing, storing and transmitting.

19. A data automation process in accordance with claim 16 including:
inputting supplemental data into said electronic communications device with an electronic inputting device selected from the group consisting of: a wireless electronic inputting device, wired inputting device, touch screen, touch pad, screen pad, keypad, keyboard, wireless keyboard, keys, buttons, electronic mouse, wireless mouse, audible input device, transmitter and combinations of any of the preceding inputting devices; and
said electronic display screen is selected from the group consisting of: a monitor, touch screen, electronic visual screen, impact-resistant screen, screen with an accelerator, light emitting display, touchpad, and combinations of any of the preceding.

20. A data automation process in accordance with claim 16 wherein:
said healthcare source data is selected from the group consisting of: personal health information (PHI), electronic medical records (EMR), electronic health records (EHR), diagnostic information, health insurance information, medical claims, clinical data, clinical trials, laboratory test results, medical test results, genetic testing results, laboratory information, disease information, treatment data, chronic disease data, medical information, medical condition information, public health information, epidemiological information, pharmaceutical data, demographic information, geographical information, identifying data, age, race, first name, last name, legal name, social security number, identification number, passport information, driver's license, personal information, date of birth, biometric data, behavior information, psychological information, patient information, patient conditions, patient temperature, patient blood pressure, patient allergies, patient medical history, patient treatment, patient prognosis, patient diagnosis, patient allergies, patient medical injections, patient shots, patient prescribed medicine, pulse readings, blood type, blood analysis, fingerprints, hair color, eye color, eye scan, cornea scan, iris scan, retina scan, eye pressure, finger prints, teeth identification, dental records, DNA information, level 7 (HL7 v2.x) data, ventilator records, LOINC coded data, ICD-9 coded data, ICD-10 coded data, and combinations of any of the preceding source data;
said healthcare-source data system is operable for a source selected from the group consisting of: a hospital, medical center, healthcare facility, healthcare provider, medical office, managed care facility, medical personnel, physician, physician specialist, dentist, podiatrist, veterinarian, U.S. public health official, nurse practitioner, certified registered nurse anesthetist, clinical nurse specialist, medical psychologist, physician assistant, clinic, paramedic, emergency medical technician, ambulance technician, laboratory, government agency, pharmacist, pharmacy, pharmaceutical company, health insurance company, actuary, claim system, health plan provider, insurer, laboratory information management system (LIMS), laboratory information system (LIS),laboratory management system (LMS), electronic prescribing system (E-Rx), radiology information system (RIS), hospital information system (HIS), health care information system, medical picture archiving and communications system (PACS), medical imaging system, digital imaging and communications in medicine, level 7 (HL7 v2.x) data standard system, ventilator records system, point of care (POC) system, care management system, cardiographs, respirator, medical device, healthcare effectiveness data and information set (HEDIS) system, health maintenance organization (HMO), center for Medicare and Medicaid services (CMS), agency for healthcare research and quality (AHRQ), clinical information system (CIS), patient data management system (PDMS), emergency management information system (IMIS), geographical information system (GIS), center for disease control and prevention (CDC), health insurance portability and accountability act (HIPAA) eligibility transaction system (HTS), and combinations of any of the preceding sources;
said standardized healthcare data is used for at least one use selected from the group consisting of: medical diagnosis, medical analysis, disease management, healthcare management, healthcare risk management, emergency management, health care insurance, public health surveillance and monitoring, predictive epidemiology systems. and combinations of the preceding uses;
said electronic communications network is selected from the group consisting of a global communications network, internet, wide area network (WAN) local area network (LAN), WiFi network, Bluetooth network, and combinations of any of the preceding networks; and
each of said devices are selected from the group consisting of: a wired electronic communications device, a wireless electronic communications device, central processing unit (CPU), server, microprocessor, lap top computer, desk top computer, electronic computing device, computer, electronic device radiotelephone, cellular (cell) phone, mobile phone, smart phone, qwerty phone, flip phone, slider phone, android phone, tablet phone, camera phone, clamshell device, portable networking device, portable personal digital assistant (PDA), wireless e-mail device, internet communication device, tablet device, android tablet, ipod, ipad, kindle, electronic monitor, blackberry, tablet device, video device, electronic processor, mobile computing device, computer, netbook, data sharing device, wireless device, handheld electronic communications device, data sharing device, a hand held electronic device, and combinations of any of the preceding.
